(19) United States
(12) Patent Application Publication
(10) Pub. No.: US 2005/0263189 A1
(43) Pub. Date: Dec. 1, 2005

(54) Pressure regulator

(75) Inventor: Yasuaki Nakamura, Shizuoka-ken (JP)

Correspondence Address: FITZPATRICK CELLA HARPER & SCINTO, 30 ROCKEFELLER PLAZA, NEW YORK, NY, 10112, US

(73) Assignee: Tokai Corporation, Tokyo (JP)

(21) Appl. No.: 11/139,964

(22) Filed: May 27, 2005

(30) Foreign Application Priority Data
May 28, 2004 (JP) 159040/2004

(51) Int. Cl. G05D 16/06

(52) U.S. Cl. 137/505.42

(57) ABSTRACT

A pressure regulator include a fluid introducing port; a primary regulating valve for reducing the primary pressure to a secondary pressure; a pressure regulating chamber receiving the fluid from the first pressure regulating valve; a diaphragm which is being displaced in response to the secondary pressure; a shift for drivingly connecting the diaphragm and the primary regulating valve; a pressure-setting section for adjusting a displacement magnitude of the diaphragm; and a discharging port through which the fluid of secondary pressure is discharged. The shaft includes a secondary regulating valve operatively associated with the primary regulating valve so as to further regulate the fluid from the primary regulating valve by opening-closing operations in reverse to those of the primary regulating valve. Hence, the pressure regulation characteristic of the secondary regulating valve against the fluctuations in the primary pressure become reverse to that of the primary regulating valve.

### BACKGROUND OF THE INVENTION

1. Field of the Invention

The present invention relates to a pressure regulator for reducing a primary pressure to a constant secondary pressure, and more specifically relates to a pressure regulator having a feature suitable for use for ensuring a stable fuel supply over an extended period, for example, when supplying a fuel cell with a low pressure liquid fuel or a gaseous fuel.

2. Description of the Related Art

Conventionally, pressure regulators, also referred to as pressure governors, for reducing the pressures of the high-pressure gases have been utilized widely in liquefied gas utilizing appliances, gas supply facilities, and the like. The pressure regulator includes a diaphragm for detecting a secondary pressure; and a pressure-regulating valve movable in association with the displacement of the diaphragm, and is structured such that the pressure-regulating valve is operated to keep the secondary pressure constant even if the primary pressure of the introduced gas is subjected to fluctuations, thereby providing a predetermined secondary pressure (see, for example, Japanese unexamined Patent Publication No. 8(1996)-303773).

A variety of pressure regulators having various structures designed depending on a range of possible primary pressures, required response characteristics, and required stability have been put to practice. Based on the required quality of the secondary pressure, one or more types of pressure regulators are used in combination for obtaining the target secondary pressure.

A basic structure of a typical pressure regulator will be described hereinbelow with reference to FIGS. 10A and 10B. FIG. 10A is a schematic view showing a single-valve type pressure regulator. A pressure regulator 200 comprises: a diaphragm 204 for defining a pressure regulating chamber 202 within a casing 201; an introducing port 205 through which a high-pressure gas having a primary pressure is introduced into the pressure regulator; a regulating valve 206 which is drivingly connected with the diaphragm 204 and serves to open and close an aperture 206c which communicates between the introducing port 205 and the pressure regulating chamber 202 in order to reduce and regulate the primary pressure to the secondary pressure; a discharging port 208 through which the gas of secondary pressure having passed through the pressure regulating chamber 202 is discharged; and a pressure regulating spring 209 which urges the diaphragm 204 toward the direction of opening the regulating valve 206 and thereby sets the secondary pressure.

The principle of the single-valve type pressure regulator 200 is based upon detection of a pressure difference between the atmospheric pressure and the secondary pressure. The force produced based on an area of the diaphragm 204 and the pressure difference between the atmospheric pressure and the secondary pressure acts in a direction towards the closed position of the regulating valve 206, and the urging force of the pressure regulating spring 209 acts in a direction toward the open position of the regulating valve 206. The secondary pressure is kept at the set pressure in a state in which the force occurring from the area of the diaphragm 204 and the pressure difference between the atmospheric pressure and the secondary pressure and the urging force of the pressure regulating spring 209 are balanced with each other. If the pressure on the gas discharging side, i.e. the secondary pressure in the pressure regulating chamber 202, is higher than the set pressure, the diaphragm 204 is displaced toward the atmospheric chamber 204 side, and the regulating valve 206 is operated in the direction that closes the aperture 206c. On the other hand, if the secondary pressure in the pressure regulating chamber 202 is lower than the set pressure, the diaphragm 204 is displaced toward the pressure regulating chamber 202 side, and the regulating valve 206 is operated in the direction that opens the aperture 206c. More specifically, the motion caused by the aforesaid pressure difference is transmitted to the regulating valve 206 disposed on the gas introducing side, and the secondary pressure is kept constant through the pressure regulation by opening and closing the regulating valve 206.

In the single-valve type pressure regulator 200, however, a pressure loss occurs due to the gas flow through the regulating valve 206. This pressure loss and the area of the regulating valve 206 cause in combination an excess force that displaces the diaphragm 204 towards the atmospheric chamber side, i.e., a force in the direction closing the regulating valve 206. This force increases with the increased primary force as a result that the regulating valve 206 opens or closes the aperture 206c from the primary pressure side. As the primary pressure becomes higher, the secondary pressure gradually decreases, and the gas stream is finally ceased.

FIG. 10B is a schematic view showing a duplex-valve type pressure regulator. This duplex-valve type pressure regulator 300 comprises: a diaphragm 304 for defining a pressure regulating chamber 302 within a casing 301; an introducing port 305 through which a high-pressure gas having a primary pressure is introduced into the pressure regulator; a regulating valve 306 which is drivingly connected with the diaphragm 304 and serves to open and close a first aperture 206c which communicates between the introducing port 305 and the pressure regulating chamber 302 in order to reduce and regulate the primary pressure to the secondary pressure; a subsidiary regulating valve 307 which is similarly drivingly connected with the diaphragm 304 and serves to open and close a second aperture 307c which communicates between the introducing port 305 and the pressure regulating chamber 304 via a diversion 303 in order to reduce and regulate the primary pressure to the secondary pressure; a discharging port 308 through which the gas of secondary pressure having passed through the pressure regulating chamber 302 is discharged; and a pressure regulating spring 309 which urges the diaphragm 304 toward the direction of opening the regulating valve 306 and the subsidiary regulating valve 307 and thereby sets the secondary pressure.

The aforementioned two valves, i.e., the regulating valve 306 and the subsidiary regulating valve 307, are arranged such that the regulating valve 306 performs the operations for opening and closing the aperture 306c, which communicates with the pressure regulating chamber 302, from the primary pressure side, and such that the other regulating valve 307 performs the operations for opening and closing the aperture 307c from the secondary pressure side. Therefore, with the duplex-valve type pressure regulator 300, the force due to the pressure loss caused through the regulating valves 306 and the force due to the pressure loss caused through the subsidiary regulating valve 307 act in opposite directions and therefore cancel each other. This enables compensation for the drop of the secondary pressure with the increased primary pressure, thereby keeping the secondary pressure constant.

As described above, the duplex-valve type pressure regulator 300 has good performance. However, in the duplex-valve type pressure regulator, it is difficult to appropriately position the two regulating valves 306 and 307. Even if the regulating valves 306 and the subsidiary regulating valve 307 can be positioned such that both of the regulating valves 302 and 307 simultaneously contact their valve seats, the pressure losses of the gas streams passing through the respective regulating valves are not necessarily equal to each other. Hence, it is very difficult to constitute the duplex-valve type pressure regulator 200 such that the forces exerted by the primary pressure upon the regulating valves 307 and 307 are completely canceled by each other.

Ideally, the pressure regulator as described above should always provide a stable constant secondary pressure irrespective of the fluctuations in the primary pressure. In practice, for the single-valve type pressure regulator having a simple diaphragm and a regulating valve, however, the pressure loss at the regulating valve causes decreases of the secondary pressure with increases of the primary pressure as described above, and accordingly it is difficult to accurately provide a target secondary pressure with respect to a wide primary pressure range. On the other hand, for the duplex-valve type pressure regulator having a subsidiary regulating valve for canceling the pressure lose that the regulator undergoes, the body structure is large and complex compared with the single-valve type pressure regulator. Further, in the duplex-valve type pressure regulator, positioning of these two valves is difficult since a precise alignment of the valves to one another is required. Thus, the duplex-valve type pressure regulator is superior in operating principles, but not adequate for practical applications.

The present invention focuses on developing pressure regulators which are applicable to pressure regulation for supplying, for example, a fuel cell itself with a fuel therefor. In this case, however, it must be taken into account that the fuel supply to a fuel cell may be carried out at a very low pressure, and there is a need to achieve a smaller overall regulator size.

In other words, the fact that the secondary pressure is low means that if the pressure regulation accuracy is not enhanced by reducing the fluctuation range of the secondary pressure, the secondary pressure can become 0 (zero) when the secondary pressure is directed towards the low pressure end. Thus, it is required to keep the secondary pressure constant irrespective of a wide range of fluctuations in the primary pressure by some factors and thereby achieve an accurate regulation to a set pressure.

Further, for example, a pressure vessel containing a fuel for fuel cells must be replaced with a new one when the fuel contained therein is used up. During this replacement, leakage of the fuel should be prevented. Thus, the leakage preventing mechanism as well as the pressure regulating mechanism is required to be compact.

In view of the foregoing, an object of the present invention is to provide a pressure regulator having a mechanism which is small and simple in design yet particularly reliable in regulation, even in a low pressure range, of primary pressure to a constant secondary pressure when regulating a fluid to have a constant secondary pressure irrespective of fluctuations in the primary pressure.

### SUMMARY OF THE INVENTION

According to the present invention, there is provided a pressure regulator comprising: a gas introducing port, through which a fluid having a primary pressure is introduced into the pressure regulator, a primary regulating valve for reducing and regulating the primary pressure to a secondary pressure; a pressure regulating chamber into which the fluid which has passed through the first regulating valve flows; a diaphragm for partitioning off the pressure regulating chamber and an atmospheric chamber from each other, and being displaced in response to a secondary pressure within the pressure-regulating chamber; a shaft for drivingly connecting the diaphragm and the primary regulating valve; a pressure-setting section for adjusting a displacement magnitude of the diaphragm; and a discharging port through which the fluid of secondary pressure is discharged.

The shaft has a secondary regulating valve that operates in association with the primary regulating valve so as to regulate the fluid flowing into the pressure regulating chamber through the primary regulating valve by opening-closing operations inversely or in the opposite manner to the primary regulating valve, so that the pressure regulation characteristic of the secondary regulating valve against the fluctuations in the primary pressure is reverse to the pressure regulation characteristic of the primary regulating valve.

At this time, it is preferable that both the pressure loss that a projected area of the primary regulating valve undergoes and the pressure loss that a projected area of the secondary regulating valve undergoes act on the shaft in the same direction.

The shaft may be divided into a first shaft section for holding the primary regulating valve and a second shaft section for holding the secondary regulating valve, so that a casing is divided between the first and second shaft sections so as to be removable. At this time, it is preferable that a removable block including the primary regulating valve is attached to a pressure vessel containing therein a fluid to be supplied, while a body block including the secondary regulating valve is mounted to a device for receiving the fluid from the pressure vessel. It is also preferable that the first shaft section of the shaft provided for holding the primary regulating valve has a valve spring that urges the first shaft section toward the closing direction of the primary regulating valve and retains the primary regulating valve closed when the first shaft section is separated from the second shaft section for holding the secondary regulating valve.

Meanwhile, it is also preferable that the primary regulating valve and the secondary regulating valve are disposed on the shaft so as to be separated from each other leaving a predetermined space therebetween, and are operatively associated with each other such that the valves open and close a single aperture in a reverse relationship to each other on either side of the aperture.

The present invention is applicable when the fluid is a liquid fuel for fuel cells such as a methanol solution or an ethanol solution and when the fluid contains dimethyl ether.

According to the invention as described above, the shaft that is operated by a diaphragm that is displaced in response to a secondary pressure comprises: a primary regulating valve for reducing a primary pressure to the secondary pressure; and a secondary regulating valve that is operatively associated with the primary regulating valve so as to further regulate a fluid passed through the primary regulating valve by opening-closing operations in reverse to those of the primary regulating valve, as a result of which the pressure regulation characteristic of the secondary regulating valve against the fluctuations in the primary pressure is reverse to the pressure regulation characteristic of the primary regulating valve. By combining these two valves having the pressure regulation characteristics reverse to each other, the primary pressure can be more accurately reduced and regulated to the secondary pressure, and a situation that the secondary pressure becomes zero is avoided even during the regulation to the secondary pressure which is low, and a constant secondary pressure can be maintained with a simpler structure.

When the pressure loss that a projected area of the primary regulating valve undergoes and the pressure loss that a projected area of the secondary regulating valve undergoes are provided such that they act in the same direction, the pressure regulation characteristics of these valves which are reverse to each other can be easily ensured while simplifying the mechanism.

Still further, when the primary regulating valve and the secondary regulating valve are disposed such that they respectively act in directions which are different from each other, good pressure regulation characteristics can be obtained even when the dimensional accuracy regarding the positional relationship between these regulating valves is not so strict. This facilitates the manufacture of the pressure regulator.

In addition, the secondary regulating valve in a non-operating state also serves as a check valve, which prevents backflow of the fluid and therefore avoids effects of fluid leaks to a system in which the pressure regulator is incorporated. Thus, the pressure regulator of the present invention is suitable for practical application.

Particularly, when the shaft is divided into the first shaft section for holding the primary regulating valve and the second shaft section for holding the secondary regulating valve so that the casing is divided between these shaft sections so as to be removable, the pressure vessel containing therein a fluid can be easily removed from the pressure regulator and replaced with new one. Thus, such a configuration is suitable for use in a fuel supply system for fuel cells.

On the other hand, when the primary regulating valve and the secondary regulating valve are disposed on the shaft so as to be separated from each other leaving a predetermined space therebetween and are operatively associated with each other such that the valves open and close a single aperture in a reverse relationship to each other on either side of the aperture, the pressure regulator can be made compact.

When the fluid is a liquid fuel for fuel cells such as a methanol solution or an ethanol solution and when the fluid contains dimethyl ether, the fluid of interest may be either in liquid form or gas form.

### BRIEF DESCRIPTION OF THE DRAWINGS

FIG. 1 is a sectional view of a pressure regulator according to one embodiment of the invention;

FIG. 2 is a sectional view of the pressure regulator in FIG. 1 in a separated state;

FIG. 3 is a sectional view showing a pressure regulator according to another embodiment of the invention during supplying a fluid;

FIG, 4 is a sectional view showing the pressure regulator in FIG. 3 in a non-operating state;

FIG. 5 is a mechanical illustration for illustrating a pressure regulating function of the pressure regulator according to the invention;

FIG, 6 shows a pressure regulation characteristic of a secondary pressure against a primary pressure;

FIG. 7 is a sectional view showing a state that a pressure vessel is coupled to the pressure regulator according to the embodiment shown in FIG. 1;

FIG, 8 is a graph showing a pressure regulation characteristic of an example when the secondary pressure is set high, together with a comparative example;

FIG. 9 is a graph showing a pressure regulation characteristic of another example when the secondary pressure is set low; and

FIGS. 10A and 10B show schematic views respectively illustrating fundamental structures of ordinary pressure regulators.

### DESCRIPTION OF THE PREFERRED EMBODIMENTS

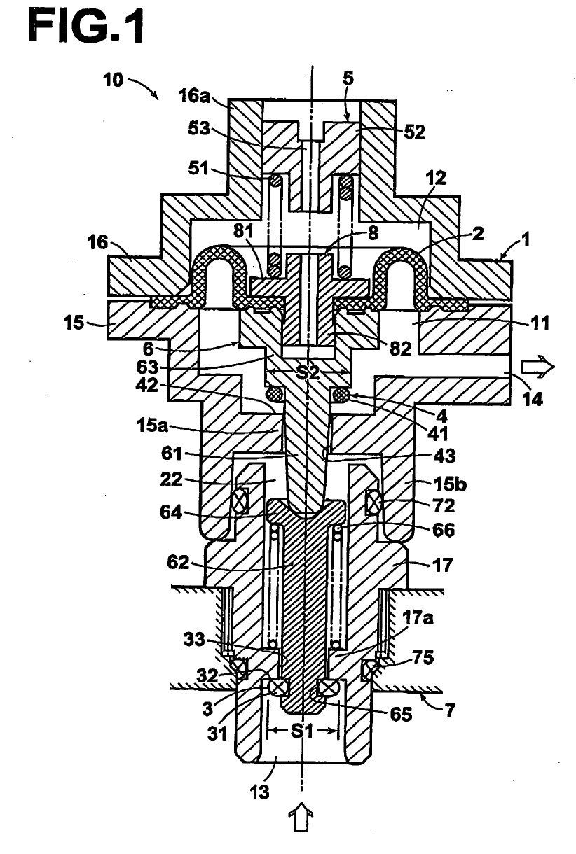

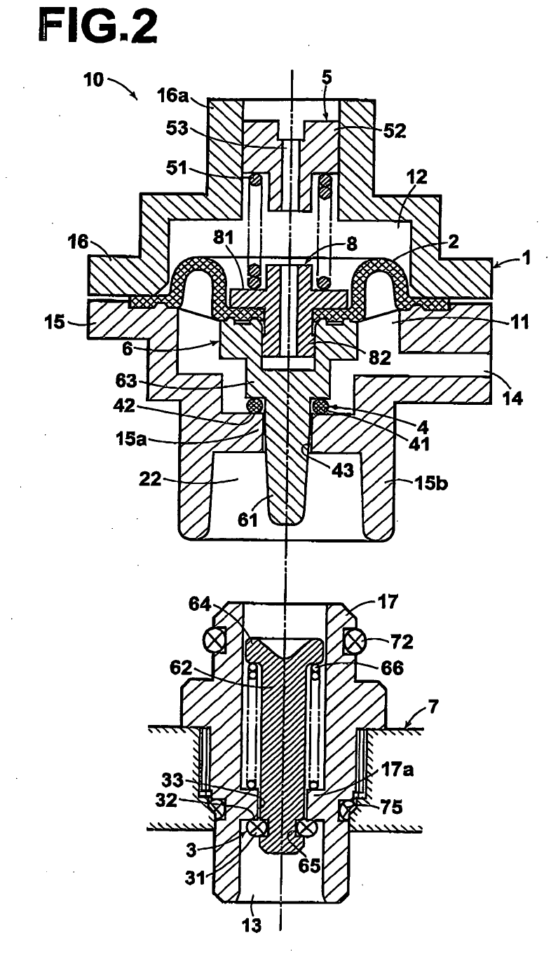

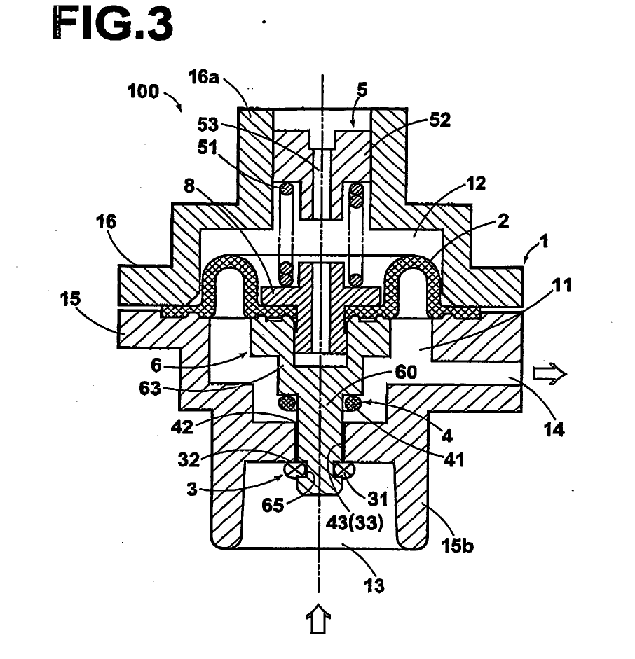

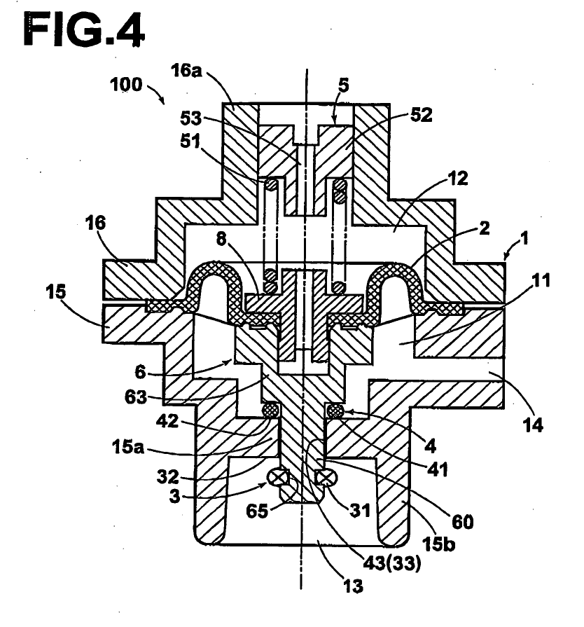

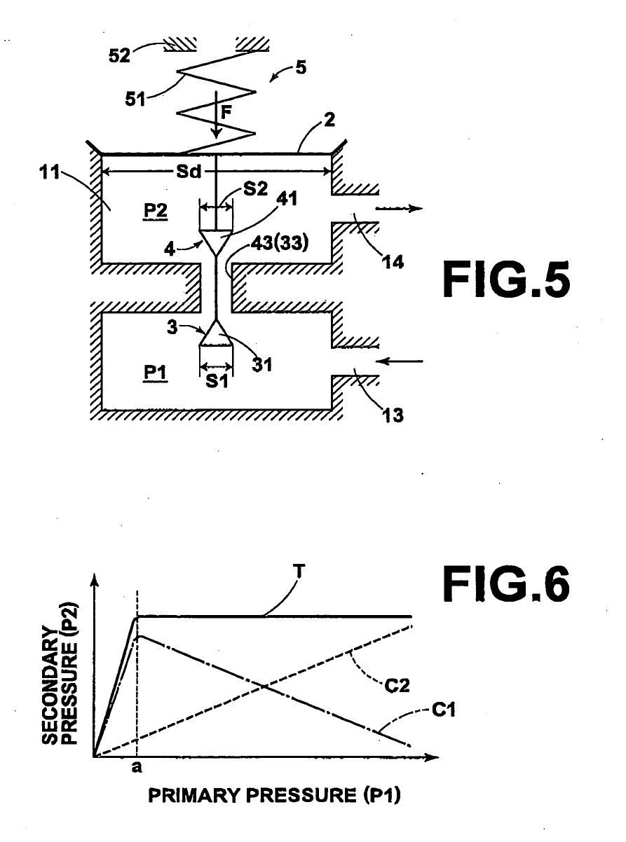

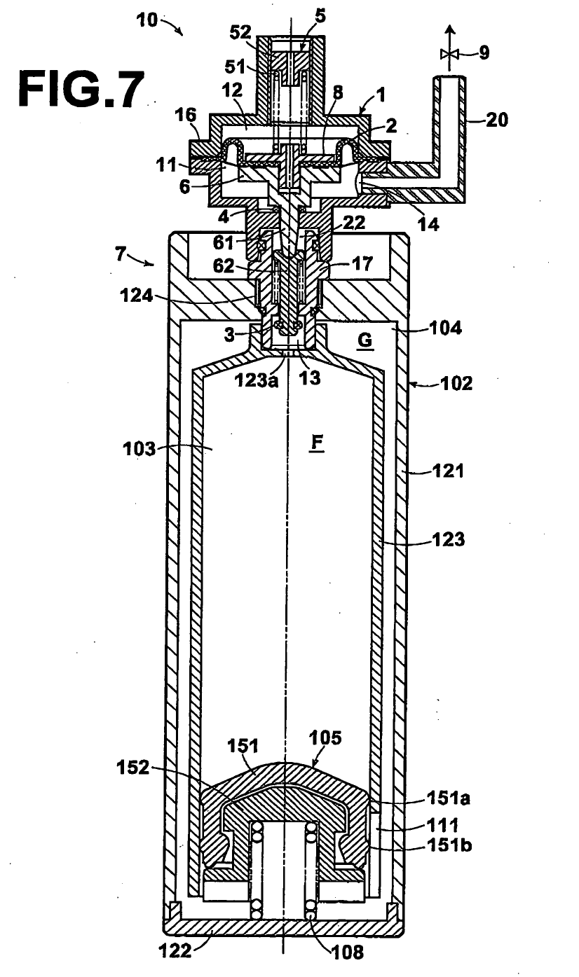

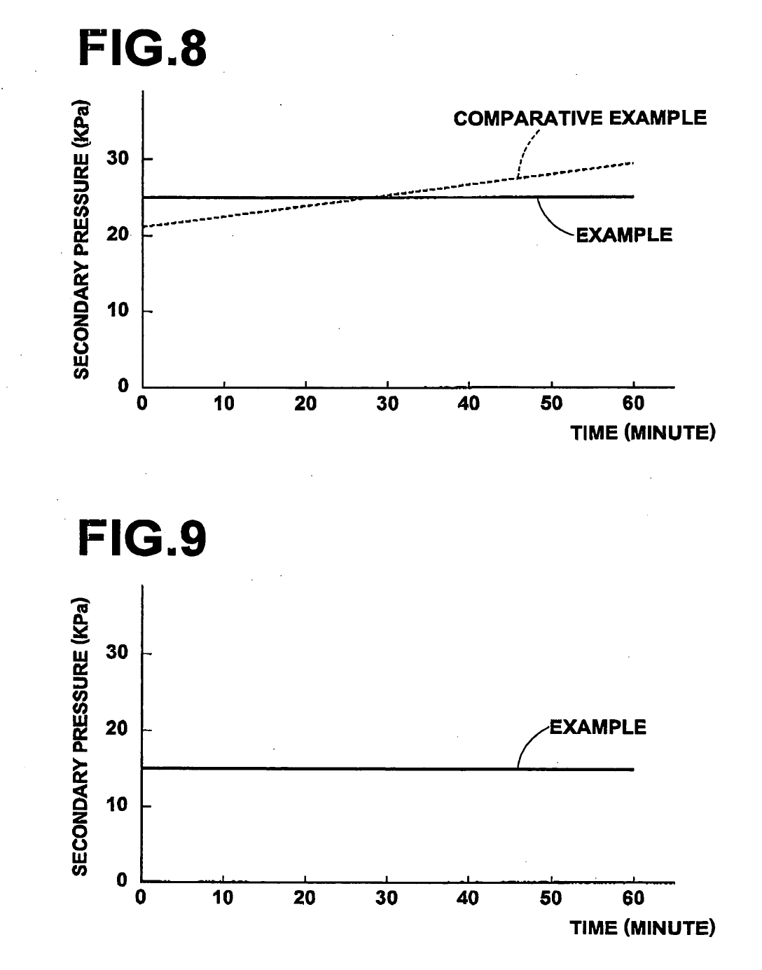

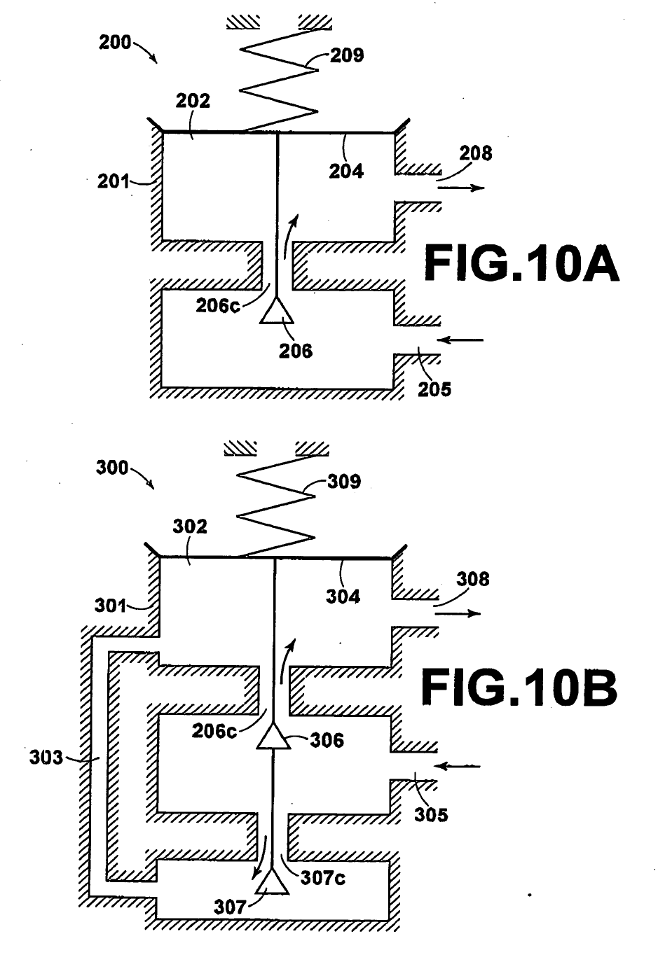

An embodiment of the present invention will hereinbelow be described in detail with reference to the accompanying drawings. FIG. 1 is a sectional view of a pressure regulator according to one embodiment of the invention; FIG. 2 is a sectional view of the pressure regulator in FIG. 1 in a separated state; FIG. 3 is a sectional view of a pressure regulator according to another embodiment of the invention during supplying of a fluid; and FIG. 4 is a sectional view showing the pressure regulator in FIG. 3 in a non-operating state. FIG. 5 is a mechanical illustration for illustrating a pressure regulating function of the pressure regulator according to the invention; and FIG. 6 shows a pressure regulation characteristic of a secondary pressure against a primary pressure. FIG. 7 is a sectional view showing a state in which a pressure vessel for fuel cells is coupled to the pressure regulator according to the embodiment shown in FIG. 1. FIG. 8 is a graph showing the pressure regulation characteristic of an example when the secondary pressure is set high; and FIG. 9 is a graph showing a pressure regulation characteristic of another example when the secondary pressure is set low.

The pressure regulator 10 according to a first embodiment of the invention shown in FIG. 1 comprises: a diaphragm 2 which partitions off a region within a casing 1 into a pressure regulating chamber 11 and an atmospheric chamber 12; an introducing port 13 through which a fluid (liquid or gas) having a primary pressure is introduced into the pressure regulator; a primary regulating valve 3 which operates in association with the diaphragm 2 to regulate the fluid pressure to reduce it to the secondary pressure by opening/closing an aperture 33 which communicates between a preliminary room 22 and the pressure regulating chamber 11 from the side opposite the pressure regulating chamber 11; a secondary regulating valve 4 which operates in association with the diaphragm 2 to carry out preliminary pressure reduction of the primary pressure by opening/closing an aperture 43 which communicates between the introducing port 13 and the preliminary chamber 22 from the pressure regulating chamber 11 side; a discharging port 14 for discharging the gas of secondary pressure having been pressure-regulated in the pressure regulating chamber 11; and a pressure setting section 5 for adjusting a magnitude of displacement of the diaphragm 2 which is displaced in response to the secondary pressure within the pressure regulating chamber 11.

Further, the diaphragm 2, the regulating valve 3, and the secondary regulating valve 4 are linked to one another by a shaft 6 to drivingly connect the components together. The casing 1 has a divisible construction constituted by a body block and a removable block. The body block comprises: a body section 15 housing the diaphragm 2 and the secondary regulating valve 4; and a cover section 16. The removable block comprises a removable section 17 that houses the primary regulating valve 3 and is removably attached to the casing body section 15.

The primary regulating valve 3 and the secondary regulating valve 4 operate in association with the movement of the shaft 6 along with the displacement of the diaphragm 2 so as to regulate the primary pressure to the secondary pressure by opening-closing operations in the opposite manner to each other, wherein the pressure regulation characteristic of the primary regulating valve 3 with respect to the primary pressure is reverse to the pressure regulation characteristic of the secondary regulating valve 4.

Therefore, the shaft 6 undergoes in the same direction the, pressure loss when the primary pressure acts on a projected area S1 of the primary regulating valve 3 and the pressure loss when the secondary pressure acts on a projected area S2 of the secondary regulating valve 4. Thus, the combination of the pressure regulation characteristics of the primary and secondary regulating valves 3 and 4 serves to compensate for variations in the secondary pressure due to the variation of the pressure loss depending on the fluctuations in the primary pressure so that the secondary pressure is kept constant.

The primary regulating valve 3 and the secondary regulating valve 4 are respectively seated on valve seat 32 and 42 from opposite directions to each other along the movement of the shaft 6. Accordingly, the opening-closing operations of the primary regulating valve 3 and the secondary regulating valve 4 are carried out inversely or in the opposite manner to each other, which contributes to reduce or eliminate the variations in the regulated pressure due to the positional deviation of the mounted locations of the valves 3 and 4. As a result, the construction accuracy is relaxed, whereby the manufacturing process is simplified.

The structure of the pressure regulator will hereinbelow be described in detail. As described above, the casing 1 comprises a body section 15, a cover section 16, and a removable section 17. The casing body section 15 and the cover section 16 are joined to each other via the diaphragm 2. In this manner, the space within the casing is partitioned off by the diaphragm 2 into the pressure regulating chamber 11, located on the side of the casing body section 15, and the atmospheric chamber 12, located on the side of the cover section 16. The pressure regulating chamber 11 has a certain volume and is capable of reducing pressure vibrations of the gas which has passed through the primary regulating valve 3.

The diaphragm 2 undergoes the secondary pressure within the pressure regulating chamber 11 and is resiliently displaceable depending on the pressure difference from the atmospheric chamber 12. The shaft 6 is secured to a center region of the diaphragm 20 on the body section 15 side, while a supporter 18 is secured to the center region of the diaphragm 2 on the cover section 16 side. The shaft 6 and the supporter 8 can move together in the axial direction depending on the displacement of the diaphragm 2.

The shaft 6 comprises a boss section 63 which is disposed within the pressure regulating chamber 11 and secured to the diaphragm 2 therein; a first shaft section 61 axially extending from the terminal end of the boss section 63; and a secondary shaft section 62 located on the extension line from the first shaft section 61 and moved together with the first shaft section 61. The boss section 63, the first shaft section 61 and the second shaft section are separate individual parts. The second shaft section 62 has a peripheral groove section 65 at the end thereof. The valve body 31 constituted by an O-ring (i.e., an elastic body) of the primary regulating valve 3 is fitted into the peripheral groove sections 65, and the valve body 41 constituted by an O-ring (i.e., an elastic body) of the secondary regulating valve 4 is fitted into the end surface of the boss section 63 at the part near the root of the first shaft section 61.

The supporter 8 includes a bolt section 82 at a center area of a flange section 81 disposed in close contact with the diaphragm 2. The bolt section 82 extends through the center area of the diaphragm 2 and is in threaded engagement with a threaded end portion of the boss section 63 of the shaft 6 located on the side opposite the flange section 81.

One end of a pressure regulating spring 51 of the pressure setting section 5 disposed within a tubular section 16a of the cover section 16 is brought into abutment with the flange section 81 of the supporter 8. The other end of the pressure regulating spring 51 is brought into abutment with a pressure regulating screw (adjustor) 52 which is screwed in the tubular section 16a in a position-adjustable manner. The urging force of the pressure regulating spring 51 acting upon the diaphragm 2 is adjusted in accordance with the positional adjustment in the axial direction of the pressure regulating screw 52. The pressure regulating screw 52 has a communication through-hole 53 which extends axially through the center thereof. The communication through-hole 53 serves to open the atmospheric chamber 12 to the ambient atmosphere.

The removable section 17 of the casing 1 is shaped in a tubular form, and removably fitted at one end in an end tubular section 15b of the body section 15 via an O-ring 72 and affixed at the other end to the pressure vessel 7, in which the fluid is contained at the primary pressure, via another O-ring 75.

The removable section 17 has a partition wall 17a which partitions off the introducing port 13 and the preliminary room 22. An aperture 33 which is opened and closed by the primary regulating valve 3 is formed at the center area of the partition wall 17a. The second shaft section 62 of the shaft 6 is slidably inserted into the aperture 33. The periphery of the aperture in the partition wall 17a on the introducing port 13 side is formed as a valve seat 32 of the primary regulating valve 3.

An extremity end of the first shaft section 61 is abutted against a recess formed in a head portion 64 of the second shaft section 62. A valve spring (return spring) 66 is disposed in a compressed state between the back surface of the head and the partition wall 17a such that the secondary shaft section 62 is urged toward the valve closing direction of the primary regulating valve 3.

In accordance with the retraction movement of the shaft 6, the valve body 31 of the primary regulating valve 3 comes into close contact with the valve seat 32 and closes the aperture 33. when the valve body 31 moves away from the valve seat 32 and opens the aperture 33 in accordance with the advance movement of the shaft 6, a quantity of the gas depending on the degree of opening of the aperture 33 flows into the regulating chamber 11 from the introducing port 13 through the primary room 22 after passing the gap between the aperture 33 and the second shaft section 62.

Meanwhile, the body section 15 of the casing 1 has a partition wall 15a which partitions off the preliminary room 22 and the pressure regulating chamber 11. An aperture 43 which is opened and closed by the secondary regulating valve 4 is formed at the center area of the partition wall 15a. The first shaft section 61 of the shaft 6 is slidably inserted into the aperture 43. The periphery of the aperture in the partition wall 15a on the pressure regulating chamber 11 side is formed as a valve seat 42 of the secondary regulating valve 4.

In accordance with the advancing movement of the shaft 6, the valve body 41 of the secondary regulating valve 4 comes into close contact with the valve seat 42 and closes the aperture 43. When the valve body 41 moves away from the valve seat 42 and opens the aperture 43 in accordance with the retracting movement of the shaft 6, a quantity of the gas depending on the degree of opening of the aperture 43 flows into the regulating chamber 11 from the primary room 22 through the gap between the aperture 43 and the first shaft section 61.

The gas discharging port 14 for discharging the gas regulated to the secondary pressure is provided in the side surface of the pressure regulating chamber 11 so as to be open to the exterior. The gas discharging port 14 is connected to a connector 20 (see FIG. 7) which in turn is connected to a device such as a fuel cell and serves to receive the gas of the regulated pressure, so that the fluid is supplied through an opening and closing valve 9.

A set load of the pressure regulating spring 51 and a set load of a valve spring 66 are set such that the set load of the pressure regulating spring 51 is larger than that of the valve spring 66, whereby in the first state where the pressure vessel 7 is coupled to the pressure regulator, the second shaft section 62 is advanced and at least the primary regulating valve 3 is opened (not necessarily opened to its fully open position), thereby introducing the fluid of the primary pressure into the pressure regulator. These loads are also set such that the secondary regulating valve 4 is opened in association with the introduction of the fluid of the primary pressure. FIG. 1 shows a pressure regulator in a pressure regulating state in which the fuel is introduced from the pressure vessel 7 to the pressure regulating chamber 11 and the fluid regulated to the secondary pressure is supplied through the discharging port 14. Details of the pressure regulating process will be described later. Further, details on the pressure vessel 7 will be described in connection with FIG. 7.

FIG. 2 shows the pressure regulator 10 with the pressure regulator being separated into a body block and a removable block. The body block including a body section 15, a cover section 16, and a secondary regulating valve 4 of the casing is attached to a device such as a fuel cell. Therefore, when the removable block including a primary regulating valve 3 is pulled out from the body block, for example, for replacement of the pressure vessel 7, the removable section 17 comes out of the body section 15 and the second shaft section 62 is separated together with the removable section 17 from the first shaft section 61. In such a separated state, the primary regulating valve 3 is retained closed by the valve spring 66, while the secondary regulating valve 4 is retained closed by the pressure regulating spring 51. Each regulating valve 3, 4 serves as a check valve. When separated, the opening and closing valve 9 (see FIG. 7) communicating with the discharging port 14 is moved to a closed position.

FIGS. 3 and 4 are sectional views of a pressure regulator according to another embodiment of the present invention. A pressure regulator 100 of this embodiment is similar to the embodiment described above except that the pressure regulator 100 has a one-piece structure while the pressure regulator 10 has a divisible structure. Parts and portions which are basically the same as those in FIG. 1 are denoted by the same reference numerals as in FIG. 1, and descriptions thereof will be omitted.

In the pressure regulator 100 according to the particular embodiment, a shaft 6 coupled to a diaphragm 2 comprises a shaft section 60 in which a first shaft section 61 and a second shaft section 62 are integral with each other. The shaft section 60 has a peripheral groove section 65 at the end thereof. A valve body 31 of a primary regulating valve 3 is fitted into the peripheral groove section 65, and a valve body 41 of a secondary regulating valve 4 is fitted into an end surface of a boss section 63 at the part near the root of the shaft section 60. More specifically, the valve body 31 of the primary regulating valve 3 and the valve body 41 of the secondary regulating valve 4 are disposed on the shaft section 60 so as to be separated from each other leaving a predetermined space therebetween. The valve body 31 and the valve body 41 are operatively associated with each other such that the valve bodies 31 and 41 open and close a single aperture 43 (33) in a reverse relationship to each other on either side of the aperture.

An interior of a lower tubular section 15b of a body section 15 is located at an introducing port 13. The body section 15 has a partition wall 15a which partitions off the introducing port 13 and the pressure regulating chamber 11. An aperture 43 (33) is formed at the center area of the partition wall 15a. The shaft section 60 of the shaft 6 extending between the primary regulating valve 3 and the secondary regulating valve 4 is slidably inserted into the aperture 43. The periphery of the aperture in the partition wall 15a on the introducing port 13 side is formed as a valve seat 32 of the primary regulating valve 4, while the periphery of the aperture on the pressure regulating chamber 11 side is formed as a valve seat 42 of the secondary regulating valve 4. A valve spring 66 that is incorporated in the preceding embodiment is not used in this embodiment.

In a fluid supply state as shown in FIG. 3, the primary pressure is regulated to a constant secondary pressure under the action of the primary regulating valve 3 and the secondary regulating valve 4 which have regulation pressure characteristics which are reverse to one another. Further, in a non-operating state as shown in FIG. 4, the secondary regulating valve 4 is closed under the urging force of a pressure regulating spring 51.

In the foregoing pressure regulator 10, 100, the primary regulating valve 3 and the secondary regulating valve 4 are operatively associated with each other to regulate the primary pressure to a predetermined secondary pressure depending on the movement of the diaphragm 2, regardless of the magnitude of the primary pressure. Operations of the primary regulating valve and secondary regulating valve will be described below. Here, while descriptions are given in connection with the pressure regulator 10 according to the embodiment shown in FIG. 1, the pressure regulator 100 according to the embodiment shown in PIG. 3 is similar to the pressure regulator 10 except that the urging force of the valve spring 66 is not applied.

FIG. 1 shows a pressure regulating state wherein the fluid which has passed through the introducing port 13 and has been pressure-regulated by means of the primary regulating valve 3 goes to a preliminary room 22 through the aperture 33, passes through the aperture 43, and is further pressure-regulated by the secondary regulating valve 4. The pressure-regulated fluid flows into the pressure regulating chamber 11 wherein the fluid is accurately pressure-reduced to the secondary pressure, and is discharged from the discharging port 14.

The diaphragm 2 is supported by the shaft 6 and the supporter 8, and kept at a position where the force due to the pressure difference between the secondary pressure and the atmospheric pressure, the urging force of the valve spring 66 and the urging force of the pressure regulating spring 51 are balanced with each other. When the secondary pressure varies in association with a variation in quantity of the fluid discharged from the discharging port 14, fluctuations in the primary pressure, and the like, the magnitude of the displacement of the diaphragm 2 varies therewith, and accordingly the position of the shaft 6 varies. The primary regulating valve 3 and the secondary regulating valve 4 open and close with the positional change of the shaft 6 in a reverse relationship to each other, whereby the secondary pressure is kept constant. The urging force of the pressure regulating spring 51 can be changed by moving the pressure regulating screw 52 of the pressure setting section 5, whereby any desired pressure can be set as the secondary pressure.

Further, the pressure regulation characteristic of the primary regulating valve 3 with respect to the primary pressure is reverse to the pressure regulation characteristic of the secondary regulating valve 4. Accordingly, the secondary pressure with respect to decrease in the primary pressure is increased by the pressure-regulation by the primary regulating valve 3 and decreased by the pressure-regulation by the secondary regulating valve 4. Further, the shaft 6 undergoes in the same direction the pressure loss when the primary pressure acts on a projected area S1 of the primary regulating valve 3 at an extremity end of the second shaft section 62 and the pressure loss when the secondary pressure acts on a projected area S2 of the secondary regulating valve 4 at the boss section 63. Thus, the combination of the pressure regulation characteristics of the primary and secondary regulating valves 3 and 4 serves to achieve consistency of the secondary pressure against the fluctuations in the primary pressure so that the secondary pressure is kept constant.

Basic pressure regulation is as follows: when the fluid having the secondary pressure is discharged from the pressure regulating chamber 11 and the secondary pressure decreases, the diaphragm 2 causes the shaft 6 to advance downward as viewed in FIG. 1, whereby the primary regulating valve 3 is moved toward its opening direction while the secondary regulating valve 4 is moved toward its closing direction. The fluid having the primary pressure is pressure-reduced by the primary regulating valve 3, and passed to the pressure regulating vessel 11 through the preliminary room 22. Increase in secondary pressure beyond a set value in association with the reduction of the primary pressure is restricted based on the degree of opening (pressure loss) of the secondary regulating valve 4. When the secondary pressure reaches the set value, the diaphragm is displaced, whereby the shaft is retracted in the upward direction as viewed in FIG. 1. As a result, the primary regulating valve 3 is closed and the introducing amount of the fluid is reduced, thus the constant secondary pressure can be achieved.

The pressure regulation characteristic accompanied with the fluctuations in the primary pressure will be described in connection with FIGS. 5 and 6. Here, we consider the variations in the pressure received by the primary regulating valve 3 under such a situation that the primary pressure within the pressure vessel 7 gradually decreases during supplying a fluid from the pressure vessel 7. FIG. 5 is a mechanical illustration for the pressure regulator 10 shown in FIG. 1. Further, the valve spring 66 is factored into the set load of the of pressure regulating spring 51.

In FIG. 5, regarding the pressure regulation Characteristic of the primary regulating valve 3 when the variations in the received pressure are not considered, the balance of the diaphragm 2 is given by;
F+ΔZ·K=P2·Sd
where P1 is a primary pressure, P2 is a secondary pressure (pressure difference between the secondary pressure and atmospheric pressure), Sd is an effective area of a diaphragm 2, ΔZ is a displacement magnitude of the diaphragm 2, F is a set load of a pressure regulating spring 51, and K is a spring constant.

Using this formula, the secondary pressure P2 is derived as follows:
P2=(F/Sd)+ΔZ·K/Sd.
Thus, the diaphragm 2 moves to:
ΔZ=(P2·Sd/K)−(F/K).
The diaphragm 2 is stabilized at the secondary pressure given by:
P2=(F/Sd)+(ΔZ·K/Sd).

More specifically, the secondary pressure P2 becomes constant regardless of fluctuations in the primary pressure when the primary pressure P1 satisfies the relationship given by P1≧(F/Sd)+(ΔZ·K/Sd). This is represented by a solid line T shown in FIG. 6 and is an ideal pressure regulation characteristic. At a point a, the primary pressure P1=(F/Sd)+(ΔZ·K/Sd), and P2 becomes constant within a region higher than this primary pressure.

Then, considering the variations in the pressure received by the primary regulating valve 3 or the pressure loss which acts in the direction that the primary pressure causes to retract the shaft 6, with the secondary valve 4 lacking, are not considered, the balance of the diaphragm 2 is given by:
F+ΔZ·K=P2·Sd−P1·S1,
wherein S1 is a projection area of the primary regulating valve.

Using this formula, the secondary pressure P2 is derived as follows:
P2=(F/Sd)+(ΔZ·K/Sd)−(P1·S1/Sd).
Thus, the pressure regulation characteristic in this case is similar to that shown by a chain line C1 in FIG. 6 and deviated from the ideal characteristic T by “−(P1·S1/Sd)”. Thus, the secondary pressure P2 decreases with increase of the primary pressure P1. Actually, however, the internal pressure of the pressure vessel 7 decreases with the supply of fluid, and thus the secondary pressure P2 increases with decrease of the primary pressure P1, as a result of which, a constant secondary pressure P2 can not be obtained.

There has been proposed duplex-valve type pressure regulators as canceling the pressure lose ΔP1=S1·P1 which would act on the aforementioned primary regulating valve 3. In the duplex-valve type pressure regulators, a subsidiary regulating valve which is operatively associated with the primary regulating valve 3 so as to be opened and closed in the same direction as the primary regulating valve 3 is disposed on the shaft. The duplex-valve type pressure regulator is for introducing the secondary pressure simultaneously regulated by the both regulating valves into the pressure regulating chamber. The body structure thereof is complex and difficult to make compact, Further, it is also difficult to ensure accuracy to set the primary regulating valve and the subsidiary regulating valve such that they can perform opening-closing operations simultaneously.

In contrast, according to the present invention, the secondary regulating valve 4 is opened and closed in a reverse relationship to the primary regulating valve 3, and the pressure loss of the secondary regulating valve 4 is in the same direction as that of the primary regulating valve 3, and the pressure regulation characteristic of the secondary regulating valve 4 is substantially reverse to the pressure regulation characteristic of the primary regulating valve 3. Supposing that S2 is a projection area S2 of the secondary regulating valve 4, the pressure loss of the primary regulating valve 3 is given by ΔP1=P1·S1, while the pressure loss of the secondary regulating valve 4 is given by ΔP2=P2·S2. Accordingly, the balance of the diaphragm is given by:
F+ΔZ·K=P2·Sd+ΔP1+ΔP2.
Thus, the pressure regulation by the primary regulating valve 3 is given by;
P2=−[(P1·(S1+S2)/K)+[(Sd·P2)/K]−(f/K).

The pressure regulation characteristic of the primary regulating valve 3 in this case is as shown by a chain line C1 in FIG. 6 such that the secondary pressure P2 decreases with increase of the primary pressure P1. In contract, according to the pressure regulation characteristic of the secondary regulating valve 4, the secondary pressure P2 is restricted when the primary pressure P1 is low. Particularly, the secondary regulating valve 4 is closed when the primary pressure P1 is zero and serves as a check valve to prevent backflow of the fluid, while the secondary regulating valve 4 is opened with the increase of the primary pressure P1. As shown in the dotted line C2 in FIG. 6, the secondary pressure P2 increases as the primary pressure P1 increase, which is reverse to the pressure regulation characteristic C1 by the aforementioned primary regulating valve 3.

The pressure regulation characteristics C1 and C2 both act in the same direction with respect to the shaft 6, whereby the pressure regulation characteristics provided when two regulating valves which have pressure regulation characteristic reverse to each other are combined provides, as shown in the solid line T in FIG. 6, a constant secondary pressure P2 against the fluctuations of the primary pressure P1 within the range of the primary pressure P1 larger than point a. More specifically, when the primary pressure P1 reduces in association with the supply of the fluid from the pressure vessel 7, the pressure loss on the primary regulating valve 3 tends to increase the secondary pressure P2, whereas the pressure loss on the secondary regulating valve 4 tends to decrease the secondary pressure P2. Accordingly, when both are combined, the pressure regulation characteristics are cancelled to each other. Thus, maintaining the secondary pressure P2 constant is ensured with a simple structure.

Further, in the separated state and in the non-operating state, the primary regulating valve 3 and/or the secondary regulating valve 4 operate as a check valve, thereby preventing leakage of the fluid. If the flow rate is zero when the opening/closing valve 9 to a discharging section of the fluid having the secondary pressure is closed, the primary regulating valve 3 is closed, thereby preventing the secondary pressure from increasing.

FIG. 7 is a sectional view showing an operation manner of the pressure regulator 10 according to the embodiment shown in FIG. 1. The discharging port 14 of the pressure regulator 10, that is, the body block including the body section 15 of the casing 1 is fitted with the device such as a fuel cell or the like (not shown) and the opening and closing valve 9 is disposed partway along the path to the discharging port 14 through the connector 20. Meanwhile, the pressure vessel 7 containing therein a liquid fuel for fuel cells is connected to the introducing port 13 of the pressure regulator 10, that is the removable block including the removable section 17 such that the fluid thus contained is supplied to the aforementioned device at a constant pressure.

The pressure vessel 7 contains a liquid fuel F used as a fuel for fuel cells, such as a mixed solution of methanol and pure water with a predetermined concentration, or a mixed solution of ethanol and pure water with a predetermined concentration, an ethanol solution or the like, and serves to directly supply the fuel, for example, to a direct methanol fuel cell (DMFC).

This pressure vessel 7 comprises a vessel body 102 having a connection portion 124 to which the removable section 17 is affixed; a fuel storage chamber 103 that is formed within the vessel body 102 and used for containing therein a fuel fluid F; a gas chamber 104 that is formed within the vessel body 102, communicates at the end thereof with the fuel storage chamber 103, and is used for containing therein a compressed gas 0 for pressing out the fuel liquid F; a partition wall member 105 that is movably disposed in the fuel storage chamber 103 and serves to separate the fuel liquid F and the compressed gas G; and an elastic body lo to be compressed between the bottom of the vessel body 102 and the partition wall member 105 when the partition wall member 105 moves to the bottom.

The vessel body 102 is formed from resin and comprises an outer container 121 which defines the outer shape of the vessel body, a lid 122 for closing the bottom portion of the outer container 121, and an inner container 123 nested within the outer container 121 such that a dual structure is provided. The connection portion is formed in the center on top of the outer container 121.

The inner container 123 has a cylindrical shape, so that the inside of the inner container 123 and the inside of the outer container 121 are in communication with each other without joining the bottom end of the inner container 123 to the lid 122 disposed at the bottom of the outer container 121. More specifically, the bottom of the fuel storage chamber 103 and the bottom of the gas chamber 104 are in communication with each other. A vertically extending cutout 111 is formed at the bottom end of the inner container 123. The top end of the inner container 123 is fitted with the bottom end of the removable section 17 of the pressure regulator 10 such that the inner container 123 is held in place. A through hole 123a is formed in the center of the top end of the inner container 123 such that the fuel liquid F within the fuel storage chamber 103 can be discharged therefrom for supply in association with the opening-closing operation of the primary regulating valve 3.

The piston-like partition wall member 105 which has been slidably inserted into the inner container 123 is constituted by a resilient sealing member 151 and a supporting member 152. Two sealing portions 151a and 151b provided along the peripheral surface of the sealing member 151 at the upper and lower parts thereof sealingly contact with the inner surface of the cylindrical inner container 123 such that the fuel liquid F is sealed in the fuel storage chamber 103 which is the space above the partition wall member 105. The partition wall member 105 serves as a movable partition wall member for separating the fuel liquid F contained within the fuel containing chamber 103 and the compressed gas contained within the gas chamber 104. The partition wall member 105 imparts a pressure to the fuel liquid F located on the front side thereof under the pressure of the compressed gas acting on the rear side thereof, and operates to press out the fuel liquid F when the primary regulating valve 3 is opened.

While the position of the partition wall member 105 varies depending on the storage capacity of the residual fuel liquid F, and the volume of the compressed gas G changes therewith and the pressure of the compressed gas reduces, a pressure for moving the partition wall member 105 should be ensured such that the fuel liquid F can be pressed out until no more fuel liquid remains therein.

Sealing the compressed gas G into the aforementioned gas chamber 104 should be carried out with the pressure regulator 10 being in the separated state, before injecting the fuel liquid F into the fuel storage chamber 103. More specifically, the partition wall member 105 is moved downward in association with injection of the compressed gas G into the fuel storage chamber 103 through the primary regulating valve 3 which has been opened with the pushing of the second shaft section 62. By further injecting the compressed gas into the fuel storage chamber 103 compared with the condition shown in FIG. 7, the partition wall member 105 is further moved towards the bottom of the fuel storage chamber 103 while deforming the elastic body 108. At its lowermost position, the top end of the cutout 111 is located above the upper sealing portion 151a and the compressed gas is then filled into the gas chamber 104,from the fuel storage chamber 103 through the cutout 111. Injection of the compressed gas is stopped when the pressure within the gas chamber 104 reaches a predetermined pressure. After that, the primary regulating valve 3 is caused to open again to discharge the compressed gas within the fuel storage chamber 103. Accordingly, the partition wall member 105 returns to the state in which it seals the fuel storage chamber 103. The partition wall member 105 moves upward to the top end of the inner container 123 as the compressed gas is discharged, and the compressed gas 0 is sealed in the gas chamber 104 when the gas within the fuel storage chamber 103 is discharged until no more gas remains therein. Then, a fuel injecting device is coupled to the removable section 17 and the fuel liquid F is injected into the fuel storage chamber 103 through the primary regulating valve 3 while downwardly moving the partition wall member 105, so that the fuel liquid F can be expelled toward the exterior. The pressure vessel 7 is thus structured.

Further, the pressure vessel 7 may contain a fuel gas such as dimethyl ether. In such a case, the fuel gas is directly contained in the outer container without using the inner container. In addition, in order to provide an internal pressure (primary pressure) sufficient for causing ejection of the supply fluid, a propellant such as dimethyl ether may be mixed in the fluid.

The shaft 6 is advanced or retracted in response to the fluctuations in the primary pressure and operations of the opening and closing valve 9 accompanied by supply of the fluid F which has been fed from the pressure vessel 7 and regulated by the pressure regulator 10.

Then, the results of experiments for evaluating the pressure regulating effects of the pressure regulator 10 of the invention are compared with those of the pressure regulators of the comparative examples, and the comparison results are shown in FIGS. 8 and 9. A pressure regulator used in the examples of the invention was a pressure regulator according to the embodiment of the invention shown in FIG. 1 that is attached with a pressure vessel 7 as shown in FIG. 7 and serves to supply a fluid. Meanwhile, a pressure regulator used in the comparative example was the same as used in the examples of the invention except that a secondary regulating valve 4 was removed,

### MEASUREMENT EXAMPLE 1

In Measurement Example 1, fluctuations in the secondary pressure P2 were measured while changing a primary pressure P1 of a fluid supplied to a pressure regulator 10 when the secondary pressure P2 was set relatively high. The results of the measurement are shown in FIG. 8 where a solid line indicates the results of the measurement on the pressure regulator of the present invention, while a broken line indicates the results of the measurement on a comparative example.

Setting parameters used in this measurement were as follows; set secondary pressure P25 kPa; effective area 123 mm² (dia. 12.5 mm); projection area of primary regulating valve 5 mm² (dia. 2.5 mm); projection area of secondary regulating valve 7 mm² (dia. 3.0 mm); spring constant of pressure regulating spring 0.5 N/mm; wire diameter of pressure regulating spring 0.35 mm; outer diameter of pressure regulating spring 3.0 mm; total length of pressure regulating spring 15.0 mm; set length of pressure regulating spring 7.3 mm; and set load of pressure regulating spring 6.65 N.

As the fluid, a methanol solution having 90% by weight of pure water and 10% by weight of methanol was used. First, 5 ml of the methanol solution was placed in a chamber of the pressure vessel 7. The primary pressure P1 of the fluid supplied from the pressure vessel 7 changed from 300 kPA (at the start of fluid supply) to 111 kPa (at the end of fluid supply) depending on the residual amount of the fluid. Then, the flow rate was controlled such that all 5 mL of the methanol solution was supplied for 60 minutes, and the temporal change of the secondary pressure P2 was measured.

As shown in FIG. 8, in the comparative example whose measurement results were shown by a dotted line, because of lack of the secondary regulating valve 4, the secondary pressure P2 increases and fluctuates in response to the upward movement of the partition wall member 105 accompanying the decrease of the primary pressure P1 over time (during fluid supply) under the influence of the pressure loss of the primary regulating valve 3 as a result of the pressure regulating effect associated with the fluid supply. In contrast, in Example 1 whose measurement results were shown by a solid line, the secondary pressure P2 was kept constant at the set pressure by the pressure regulation effect of the primary regulating valve 3 and secondary regulating valve 4 which presents the pressure regulation characteristic reverse to the pressure regulation characteristic by the primary pressure fluctuations, and fluctuations in the secondary pressure did not occur.

Further, when the pressure vessel 7 is removed or attached, in the comparative example, the methanol solution flew back and continued to flow out. In contrast, in Measurement Example 1, the secondary regulating valve 4 was closed and serves as a check valve, whereby the methanol solution was not leaked.

### MEASUREMENT EXAMPLE 2

In Measurement Example 2, fluctuations in the secondary pressure P2 were measured while changing a primary pressure P1 of a fluid supplied to a pressure regulator 10 when the secondary pressure P2 was set relatively low. The results of the measurement are shown in FIG. 9 where a solid line indicates the results of the measurement on the pressure regulator of the present invention. The regulated pressure of the comparative example was unstable and could not be measured.

Setting parameters used in this measurement were as follows: set secondary pressure 7 kPa; effective area of diaphragm 123 mm² (dia. 12.5 mm); projection area of primary regulating valve 5 mm² (dia. 2.5 mm); projection area of secondary regulating valve 7 mm² (dia. 3.0 mm); spring constant of pressure regulating spring 0.27 N/mm; wire diameter of pressure regulating spring 0.3 mm; outer diameter of pressure regulating spring 3.0 mm; total length of pressure regulating spring 15.0 mm; set length of pressure regulating spring 6.0 mm; and set load of pressure regulating spring 1.62 N. Other aspects are like those of Measurement Example 1. The flow rate was controlled such that all 5 mL methanol solution was supplied for 60 minutes, and the time-course change of the secondary pressure was measured.

As shown in FIG. 9, in Example 2 whose measurement results were shown by a solid line, the secondary pressure P2 was kept constant at the set pressure by the pressure regulation effect of the primary regulating valve 3 and secondary regulating valve 4 which presents, as in Measurement Example 1, the pressure regulation characteristics reverse to those by the primary pressure fluctuations, and fluctuations in the secondary pressure did not occur. In contrast, as regards the comparative example, the secondary pressure was not kept stable in the range of 0 to 20 kPA, the reproducibility was not given, and the measurement was impossible.

1. A pressure regulator comprising: a gas introducing port, through which a fluid having a primary pressure is introduced into the pressure regulators a primary regulating valve for reducing and regulating the primary pressure to a secondary pressure; a pressure regulating chamber into which the fluid which has passed through the first regulating valve flows; a diaphragm for partitioning off the pressure regulating chamber and an atmospheric chamber from each other, and being displaced in response to a secondary pressure within the pressure-regulating chamber; a shaft for drivingly connecting the diaphragm and the primary regulating valve; a pressure-setting section for adjusting a displacement magnitude of the diaphragm; and a discharging port through which the fluid of secondary pressure is discharged,
wherein the shaft has a secondary regulating valve that operates in association with the primary regulating valve so as to regulate the fluid flowing into the pressure regulating chamber through the primary regulating valve by opening-closing operations in the opposite manner to the primary regulating valve, so that the pressure regulation characteristics of the secondary regulating valve against the fluctuations in the primary pressure are reverse to those of the primary regulating valve.

2. A pressure regulator as defined in claim 1, wherein both the pressure loss that a projected area of the primary regulating valve undergoes and the pressure loss that a projected area of the secondary regulating valve undergoes act on the shaft in the same direction.

3. A pressure regulator as defined in claim 1, wherein the shaft is divided into a first shaft section for holding the primary regulating valve and a second shaft section for holding the secondary regulating valve so that a casing is divided between the first and second shaft sections so as to be removable.

4. A pressure regulator as defined in claim 2, wherein the shaft is divided into a first shaft section for holding the primary regulating valve and a second shaft section for holding the secondary regulating valve so that a casing is divided between the first and second shaft sections so as to be removable.

5. A pressure regulator as defined in claim 3, wherein one removable section including the primary regulating valve is attached to a pressure vessel containing therein a fluid to be supplied, while the other removable section including the secondary regulating valve is mounted to a device for receiving the fluid from the pressure vessel.

6. A pressure regulator as defined in claim 4, wherein one removable section including the primary regulating valve is attached to a pressure vessel containing therein a fluid to be supplied, while the other removable section including the secondary regulating valve is mounted to a device for receiving the fluid from the pressure vessel.

7. A pressure regulator as defined in claim 3, wherein the first shaft section of the shaft provided for holding the primary regulating valve has a valve spring that urges the first shaft section toward the closing direction of the primary regulating valve and retains the primary regulating valve closed when the first shaft section is separated from the second shaft section for holding the secondary regulating valve.

8. A pressure regulator as defined in claim 5, wherein the first shaft section of the shaft provided for holding the primary regulating valve has a valve spring that urges the first shaft section toward the closing direction of the primary regulating valve and retains the primary regulating valve closed when the first shaft section is separated from the second shaft section for holding the secondary regulating valve.

9. A pressure regulator as defined in claim 6, wherein the first shaft section of the shaft provided for holding the primary regulating valve has a valve spring that urges the first shaft section toward the closing direction of the primary regulating valve and retains the primary regulating valve closed when the first shaft section is separated from the second shaft section for holding the secondary regulating valve.

10. A pressure regulator as defined in claim 1, wherein the primary regulating valve and the secondary regulating valve are disposed on the shaft so as to be separated from each other leaving a predetermined space therebetween, and are operatively associated with each other such that the valves open and close a single aperture in a reverse relationship to each other on either side of the aperture.

11. A pressure regulator as defined in claim 2, wherein the primary regulating valve and the secondary regulating valve are disposed on the shaft so as to be separated from each other leaving a predetermined space therebetween, and are operatively associated with each other such that the valves open and close a single aperture in a reverse relationship to each other on either side of the aperture.

12. A pressure regulator as defined in claim 1, wherein the fluid is a liquid fuel for fuel cells such as a methanol solution or an ethanol solution.

13. A pressure regulator as defined in claim 2, wherein the fluid is a liquid fuel for fuel cells such as a methanol solution or an ethanol solution.

14. A pressure regulator as defined in claim 3, wherein the fluid is a liquid fuel for fuel cells such as a methanol solution or an ethanol solution.

15. A pressure regulator as defined in claim 9, wherein the fluid is a liquid fuel for fuel cells such as a methanol solution or an ethanol solution.

16. A pressure regulator as defined in claim 10, wherein the fluid is a liquid fuel for fuel cells such as a methanol solution or an ethanol solution.

17. A pressure regulator as defined in claim 11, wherein the fluid is a liquid fuel for fuel cells such as a methanol solution or an ethanol solution.

18. A pressure regulator as defined in claim 1, wherein the fluid contains dimethyl ether.

19. A pressure regulator as defined in claim 3, wherein the fluid contains dimethyl ether.

20. A pressure regulator as defined in claim 10, wherein the fluid contains dimethyl ether.
